(19) United States
(12) Patent Application Publication
(10) Pub. No.: US 2019/0108400 A1
(43) Pub. Date: Apr. 11, 2019

(54) ACTOR-DEFORMATION-INVARIANT ACTION PROPOSALS

(71) Applicant: QUALCOMM Incorporated, San Diego, CA (US)

(72) Inventors: Victor Augusto ESCORCIA, Thuwal (SA); Mihir JAIN, Amsterdam (NL); Amirhossein HABIBIAN, Amsterdam (NL); Cornelis Gerardus Maria SNOEK, Volendam (NL)

(21) Appl. No.: 16/152,755

(22) Filed: Oct. 5, 2018

Related U.S. Application Data
(60) Provisional application No. 62/568,762, filed on Oct. 5, 2017.

(51) Int. Cl. G06K 9/00; G06K 9/62

(52) U.S. Cl. CPC G06K 9/00718; G06K 9/00758; G06K 2009/00738; G06K 9/00342; G06K 9/6215

(57) ABSTRACT

A method for generating action proposals in a sequence of frames comprises determining, at each frame of the sequence of frames, at least one possible action location for a type of actor to be detected. The method also expands, for each frame of the sequence of frames, the at least one possible action location to neighboring regions in neighboring frames from a given frame to identify a similar location between the given frame and each one of the neighboring frames. The method further comprises associating a most similar possible action location over the sequence of frames to generate the action proposals. The method also comprises classifying an action in the sequence of frames based on the action proposals and controlling an action of a device based on the classifying.

### CROSS-REFERENCE TO RELATED APPLICATION

The present application claims the benefit of U.S. Provisional Patent Application No. 62/568,762, filed on Oct. 5, 2017, and titled “ACTOR-DEFORMATION-INVARIANT ACTION PROPOSALS,” the disclosure of which is expressly incorporated by reference herein in its entirety.

### BACKGROUND

### Field

Aspects of the present disclosure generally relate to action localization and, more particularly, to systems and methods for generating action proposals in a sequence of frames.

### Background

An artificial neural network, which may comprise an interconnected group of artificial neurons (e.g., neuron models), is a computational device, or represents a method to be performed by a computational device.

An artificial neural network (ANN) may be specified to identify a set of spatiotemporal locations that correspond to an action (e.g., action proposals) in a sequence of frames, such as a video. That is, given the action proposals, the ANN may identify the spatiotemporal locations of the action in the frame. Identifying the spatiotemporal locations of the action may be referred to as action localization or localizing the action. The action may be localized based on the classification. Action localization and classification may be used for various applications in internet protocol (IP) cameras, Internet of Things (IoT), autonomous driving, and/or service robots. The action classification applications may improve the understanding of object paths for planning. For example, during autonomous driving, action localization is used to avoid collisions with pedestrians and cyclists.

Actions inherently imply the participation of one or more actors to accomplish a goal. For example, an action may be linked to a human, an animal, or an object (e.g., car). Conventional systems generate action proposals using primitives, such as color, color intensity, and/or motion vectors. The action proposals reduce a search space for localizing action by indicating an area with a high probability of an action. However, as actions are linked to entities such as objects and scenes, the primitives may be too simple to capture the complexities of an actor (e.g., entity). That is, the primitives may ignore the role of actors.

Additionally, actions may extend over multiple pixels over time. Therefore, there may be a large search space for identifying an action. Using primitives to localize action may be time consuming given the large search space. Conventional systems attempt to improve action proposal generation by training a neural network using annotated actions, at the bounding box level, in multiple frames of multiple videos. Training with annotated videos is time consuming. It is desirable to provide a system and method to improve action proposal generation in a sequence of frames.

### SUMMARY

In one aspect of the present disclosure, a method for processing a sequence of frames is disclosed. The method includes determining, at each frame of the sequence of frames, one or more possible action locations for a type of actor to be detected. The method also expands, for each frame of the sequence of frames, the one or more possible action locations to neighboring regions in neighboring frames from a given frame to identify a similar location between the given frame and each one of the neighboring frames. The method further includes associating a most similar possible action location over the sequence of frames to generate the action proposals. The method also includes classifying an action in the sequence of frames based on the action proposals. The method still further includes controlling an action of a device based on the classifying.

Another aspect of the present disclosure is directed to an apparatus including means for determining, at each frame of the sequence of frames, one or more possible action locations for a type of actor to be detected. The apparatus also includes means for expanding, for each frame of the sequence of frames, the one or more possible action locations to neighboring regions in neighboring frames from a given frame to identify a similar location between the given frame and each one of the neighboring frames. The apparatus further includes means for associating a most similar possible action location over the sequence of frames to generate the action proposals. The apparatus still further includes means for classifying an action in the sequence of frames based on the plurality of action proposals. The apparatus also includes means for controlling an action of a device based on the classification.

In another aspect of the present disclosure, a non-transitory computer-readable medium records program code for processing a sequence of frames. The program code is executed by a processor and includes program code to determine, at each frame of the sequence of frames, one or more possible action locations for a type of actor to be detected. The program code also includes program code to expand, for each frame of the sequence of frames, the one or more possible action locations to neighboring regions in neighboring frames from a given frame to identify a similar location between the given frame and each one of the neighboring frames. The program code further includes program code to associate a most similar possible action location over the sequence of frames to generate the action proposals. The program code still further includes program code to classify an action in the sequence of frames based on the plurality of action proposals. The program code also includes program code to control an action of a device based on the classification.

Another aspect of the present disclosure is directed to an apparatus for processing a sequence of frames. The apparatus has a memory and one or more processors coupled to the memory. The processor(s) is configured to determine, at each frame of the sequence of frames, one or more possible action locations for a type of actor to be detected. The processor(s) is also configured to expand, for each frame of the sequence of frames, the one or more possible action locations to neighboring regions in neighboring frames from a given frame to identify a similar location between the given frame and each one of the neighboring frames. The processor(s) is further configured to associate a most similar possible action location over the sequence of frames to generate the action proposals. The processor(s) is still further configured to classify an action in the sequence of frames based on the of action proposals. The processor(s) is also configured to control an action of a device based on the classification.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 illustrates an example of a frame with an actor in accordance with aspects of the present disclosure.

FIG. 5 illustrates an example of an action proposal generator according to aspects of the present disclosure.

FIG. 6 illustrates an example of a tube generated from a sequence of bounding boxes according to aspects of the present disclosure.

FIG. 7 illustrates an example of an actor detector according to aspects of the present disclosure.

FIG. 8 illustrates an example of matching performed based on the deformation invariant expansion according to aspects of the present disclosure.

FIGS. 9A and 9B illustrate diagrams of a system for generating an action proposal based on an affinity maximization according to aspects of the present disclosure.

FIG. 10 illustrates an example of generating an action proposal based on an affinity maximization according to aspects of the present disclosure

FIG. 11 illustrates a method for processing a sequence of frames according to an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As discussed herein, action localization infers an action that occurs at a location in a video based on predicted action locations (e.g., action proposals). That is, an action of interest is classified based on the generated action proposals. For a video, an action by an actor may extend over multiple frames of a sequence of frames. Therefore, there is a large search space for generating action proposals. Aspects of the present disclosure are directed to improving methods and systems for determining a location, in each frame, having a greatest likelihood of corresponding to an action.

As previously discussed, conventional systems use primitives and ignore the role of an actor for generating action proposals. During the performance of an action, such as an articulated action, the shape of an actor may change. That is, the actor may be deformed. For example, when performing a cartwheel, the shape of the actor changes when the actor is performing a flip. Conventional systems do not account for actor deformations. Aspects of the present disclosure use actors for generating action proposals while also accounting for actor deformations.

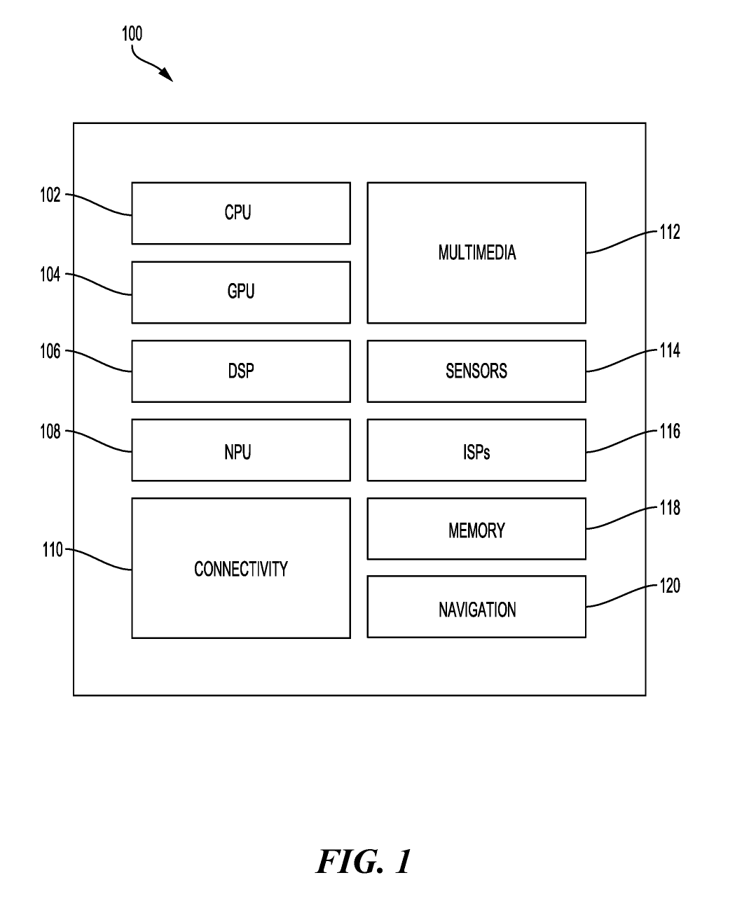

FIG. 1 illustrates an example implementation of a system-on-a-chip (SOC) 100, which may include a central processing unit (CPU) 102 or a multi-core CPU configured to generate actor-deformation-invariant action proposals in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may comprise code to determine, at each frame of the sequence of frames, at least one possible action location for a type of actor to be detected. The instructions loaded into the general-purpose processor 102 may also comprise code to expand, for each frame of the sequence of frames, the at least one possible action location to neighboring regions in neighboring frames from a given frame to identify a similar location between the given frame and each one of the neighboring frames. The instructions loaded into the general-purpose processor 102 may further comprise code to associate a most similar possible action location over the sequence of frames to generate the plurality of action proposals. The instructions loaded into the general-purpose processor 102 may still further comprise code to classify an action in the sequence of frames based on the plurality of action proposals.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

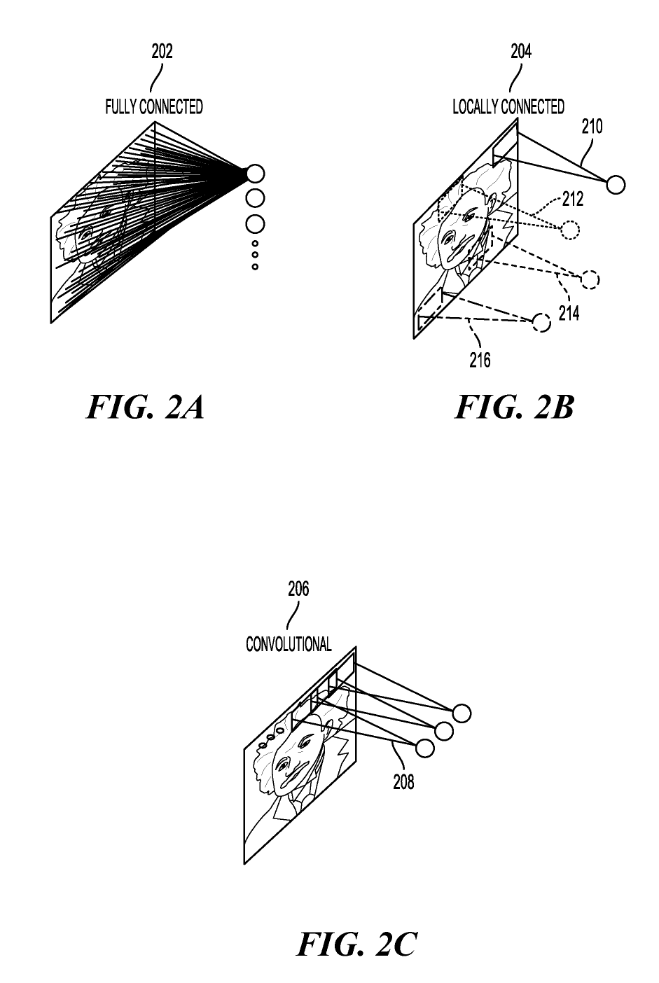

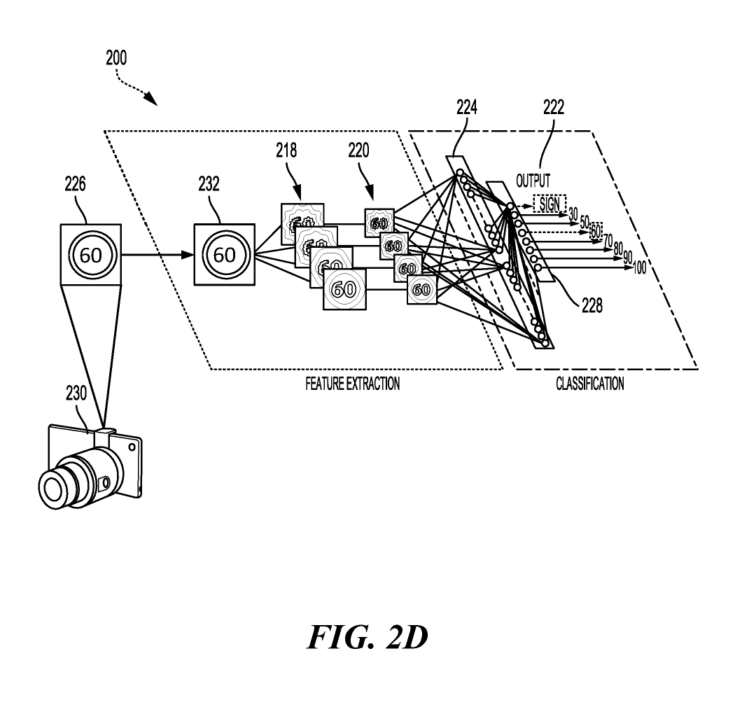

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 2×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images (e.g., the speed limit sign of the image 226) and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

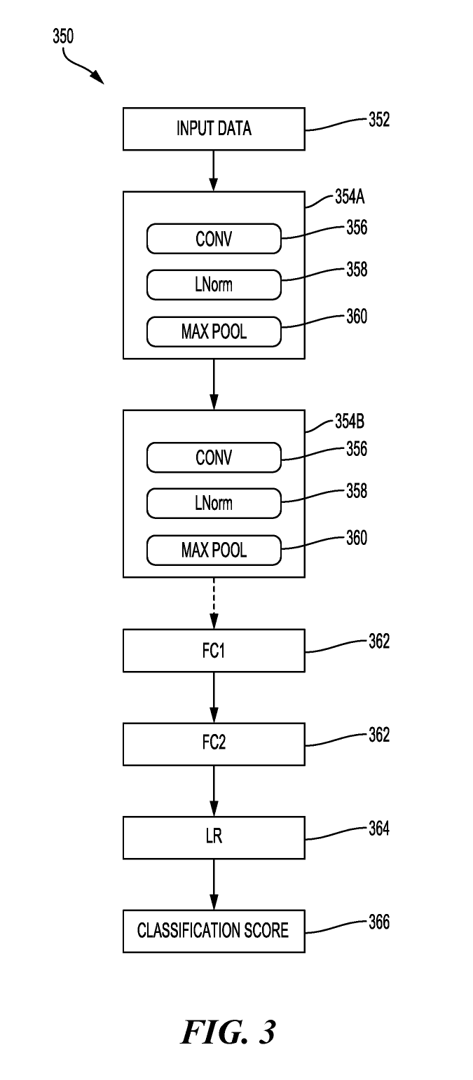

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

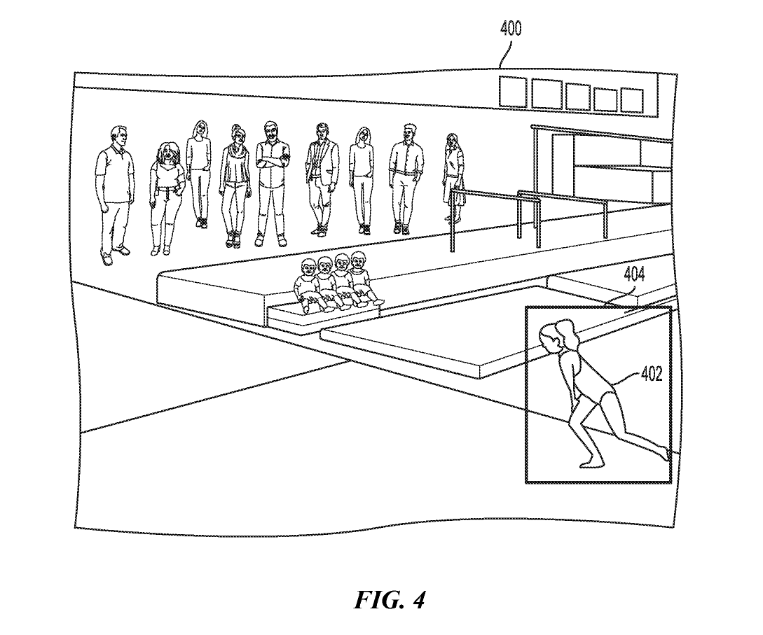

FIG. 4 illustrates an example of a frame 400 with a detected actor 402 according to aspects of the present disclosure. As shown in FIG. 4, the detected actor 402 defines the action (e.g., gymnastics) in a frame 400 of a sequence of frames. The actor 402 may be detected by an actor detector (e.g., object detector). A bounding box 404 may be drawn around the detected actor 402, such that the action within the bounding box 404 may be classified. The bounding box 404 corresponds to an action proposal of the frame 400.

A type of actor to detect may be based on an application. For example, in an autonomous vehicle, the actor detector may detect pedestrians, other cars, and bicyclists. The actor detection is action class agnostic. That is, the actor detector does not detect an actor performing a specific type of action, such as cricket bowling. Aspects of the present disclosure focus on actors to retrieve the locations that are most likely to contain actions. Action proposals may be generated based on the most likely action locations. The action may be classified based on the action proposal.

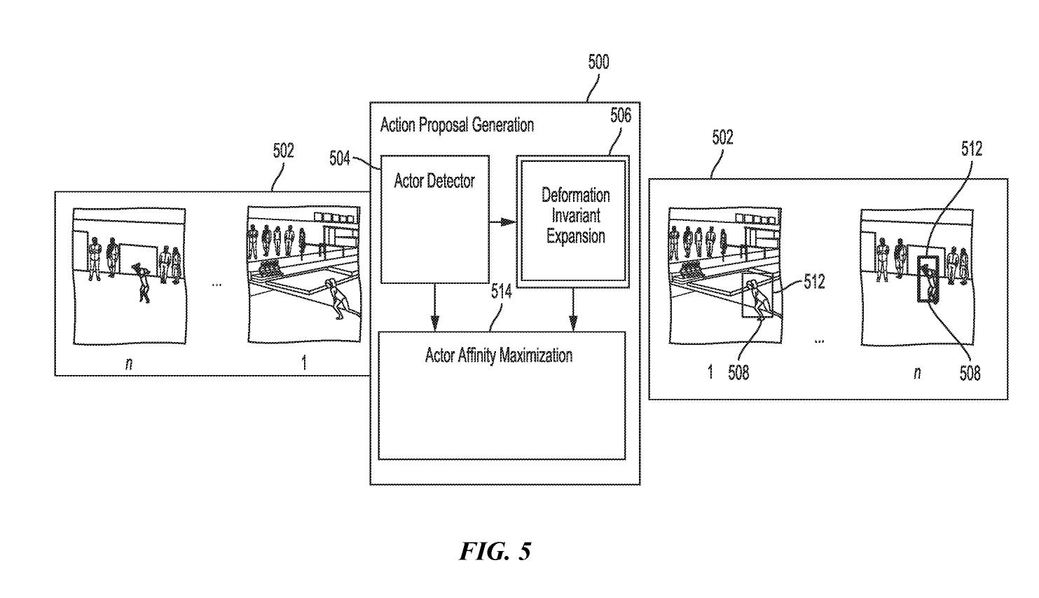

In one configuration, an action proposal is generated by detecting an actor, expanding a deformation invariant, and maximizing an actor affinity over consecutive frames. FIG. 5 illustrates an example of an action proposal generator 500 according to aspects of the present disclosure. As shown in FIG. 5, the action proposal generator 500 receives a sequence of frames 502 (1 to n) as an input. In response to receiving the sequence of frames 502, for each frame, an actor detector 504 identifies one or more possible action locations (e.g., proposed action locations) that are likely to contain an actor 508. The sequence of frames 502 may have multiple actors 508. Therefore, proposed action locations may be generated for each actor 508. Furthermore, multiple proposed action locations may correspond to a same actor 508 in a frame.

The actor detector 504 is an object detector that is pre-trained to detect one or more types of actors 508, such as a human, animal, car, etc. The actor detector 504 may be defined based on an application or a type of action that is to be identified (e.g., classified). For example, if a type of action that is to be classified (e.g., slam dunk) is performed by a human, the actor detector 504 is a human detector. As another example, in an autonomous vehicle, the actors may be vehicles, pedestrians, and bicyclists. In this example, the actor detector 504 would be a car detector, a human detector, and a bicyclist detector.

The actor detector 504 is action class agnostic. That is, the actor detector 504 detects actors 508 and does not detect classes of actions. For example, when the type of action to be identified is a slam dunk, the actor detector 504 does not detect humans performing a slam dunk. Rather, the actor detector 504 detects all humans performing an action in the sequence of frames 502. Because the actor detector 504 is not specific to an action, the actor detector 504 may identify the actor 508 performing any type of action. The actor detector 504 may be trained on images and/or videos.

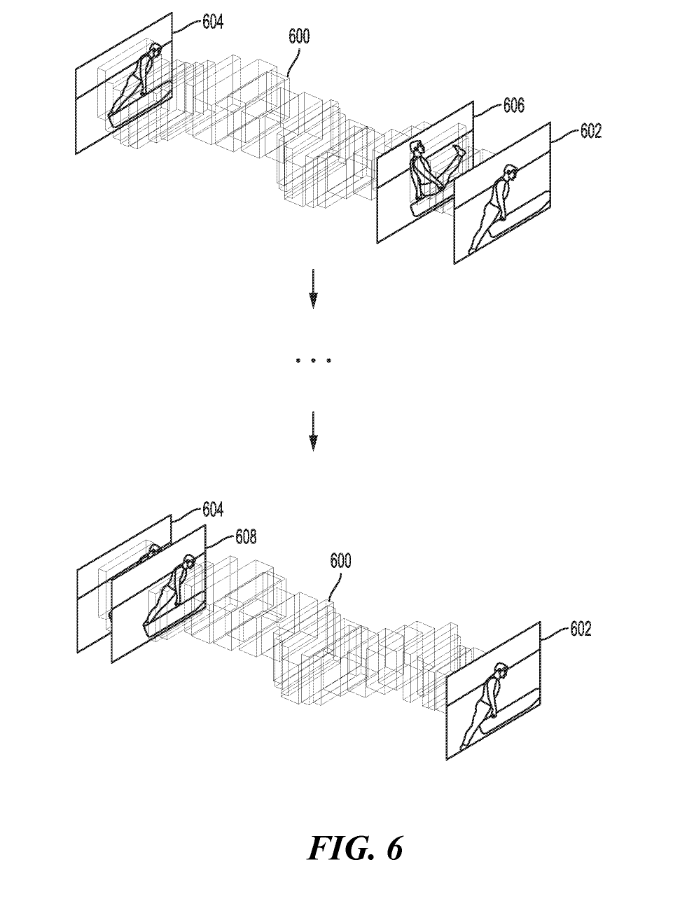

The actor detector 504 may be pre-trained based on action categories. The actor detector 504 may be any type of object detector, such as a single-shot detector (SSD), faster region-convolutional neural network (R-CNN), or any type of neural network detector. The actor detector 504 is applied to each frame of a sequence of frames 502. A box proposal may be generated around each possible actor location in each frame. Still, the box proposals of each frame may have some errors due to misdetections. Additionally, or alternatively, the box proposals may be noisy due to false positives. Because the possible actor locations have a level of uncertainty, conventional actor detectors may not generate smooth action proposal tubes. A tube is a sequence of action proposals over time (see FIG. 6).

After generating possible action locations in a current frame (x), via the actor detector 504, a deformation invariant expansion module 506 expands the possible action locations (e.g., box proposals) to neighboring regions of each frame of consecutive frames from the current frame (x). The deformation invariant expansion module 506 is used to expand possible action locations to account for an actor's change in shape. For example, when performing a flip, the shape of the actor changes from standing, to rotating, and back to standing based on the flexion and extension of muscles. The expanded possible action locations account for actor deformations.

The number of consecutive frames from the current frame (x) may be pre-determined based on the needs of an application. For example, in autonomous driving, it is desirable to reduce latency of a machine vision system. A reduced latency may improve response times to events. Thus, for autonomous driving and similar applications, the set of consecutive frames is limited to a small time frame (e.g., a few seconds). The neighboring regions are regions that correspond to a neighboring region of each box proposal of the current frame (x). The deformation invariant expansion module 506 may mitigate the misdetections of the actor detector 504 by expanding an area of the possible action locations. After generating possible action locations based on a type of actor 508 to detect and also after expanding the detections (e.g., possible action locations), the deformation invariant expansion module 506 may compare each possible action location in a frame of the consecutive frames to each possible action location of the current frame (x). Based on the comparison, a most similar location (e.g., best matching region) is determined in each frame of the consecutive frames.

The process may then be repeated for each frame in the sequence of frames 502. By repeating the process for each frame, the most similar location for each actor 508 is retained in each frame. Accordingly, each frame includes box proposals (e.g., possible action locations) generated by the actor detector 504 and possible action locations generated by the deformation invariant expansion module 506.

Furthermore, an actor affinity maximization module 514 receives frames from both the actor detector 504 and the deformation invariant expansion module 506. The actor affinity maximization module 514 then associates most similar possible action locations over the sequence of frames 502 to generate an action proposal for each actor 508 in each frame of the sequence of frames 502. Each action proposal may be identified by a bounding box 512. That is, the output of the action proposal generator 500 is the sequence of frames 502 with one or more bounding boxes 512 (e.g., annotated action proposals) for each actor 508. Each bounding box 512 may be based on box proposals generated by the actor detector 504 or a most similar location generated by the deformation invariant expansion module 506.

According to aspects of the present disclosure, an actor detector is used to detect an actor in each frame and generate box proposals around each possible location of an actor in each frame. The possible location of the actor is an area that is most likely to contain action. The possible actor locations may be identified from a pre-trained identifier, such as a person detector. Although the actor detector may identify the possible actor locations, the actor detector may not be trained to identify the articulated actions. Therefore, the actor detector may fail to propose actor locations when an actor is performing articulated actions. The box proposals may also be referred to as bounding boxes.

As discussed above, an action proposal may be generated for each frame. The action proposal is identified by a bounding box. Over time, the sequence of bounding boxes generates a tube. FIG. 6 illustrates an example of a tube 600 according to aspects of the present disclosure. As shown in FIG. 6, the tube 600 is generated based on the sequence of bounding boxes between an initial frame 602 of a sequence of frames and a final frame 604 of the sequence of frames. As a location of an action changes between frames, the location of the bounding box corresponding to the action also changes between frames. For example, the location of the action changes from the first frame 602 to a second frame 606. Likewise, the location of the action changes from the second frame 606 to a third frame 608. The movement of the bounding boxes over the sequence of frames is tracked by the tube 600. A level of uncertainty may alter the tube 600. For example, as shown in FIG. 6, the tube 600 is smooth when there is low uncertainty in the bounding boxes (e.g., proposed actor locations).

As another example, which is not shown in FIG. 6, a tube may be discontinuous when there is high uncertainty in the bounding boxes. For example, if a bounding box moves from one corner of a frame to another corner of a frame for consecutive frames, there may be a high uncertainty in the bounding boxes because, in most cases, an actor does not rapidly move from one location to another. The tube generated from bounding boxes with high uncertainty may be discontinuous based on uncorrelated locations of the bounding boxes in consecutive frames.

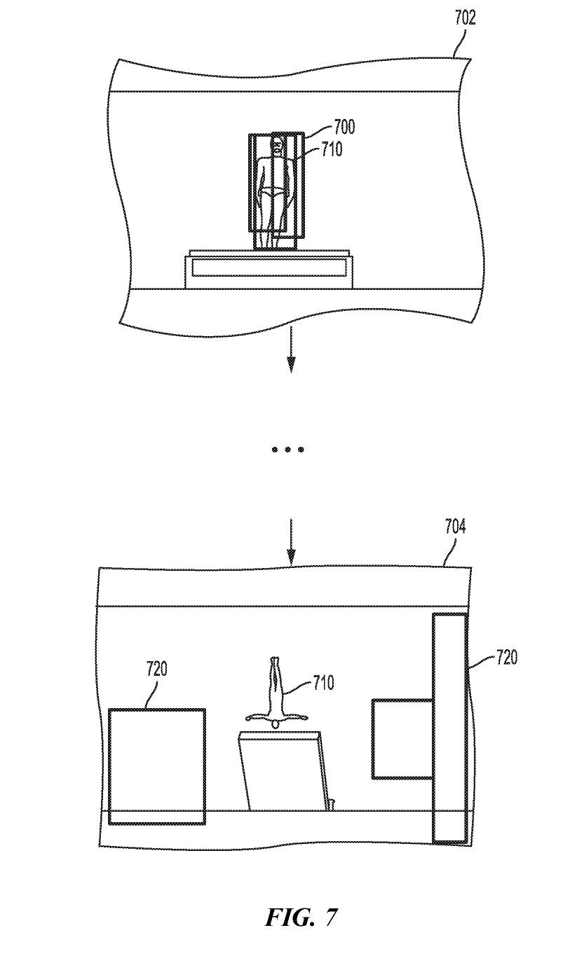

As previously discussed, conventional actor detectors may not detect deformed actors. FIG. 7 illustrates an example of an actor detector failing to detect a deformed actor. As shown in FIG. 7, at a first frame 702, the actor detector detects possible actor locations 700 of an actor 710 (e.g., human) when the actor 710 is standing still (e.g., conventional pose). In this example, the possible actor locations 700 in the first frame 702 are relative to an actual location of the actor 710.

Additionally, as shown in FIG. 7, at a second frame 704, the actor detector detects possible actor locations 720 when the actor 710 is in an articulated action (e.g., diving). In this example, when the actor 710 is in the articulated action, the possible actor locations 720 are not relative to the actor's actual location. The inaccurate possible actor locations 720 of the second frame 704 may be due to the actor detector's failure to identify the actor's articulation actions. An actor performing an articulated action may be referred to as a deformed actor. In the example of FIG. 7, the first frame 702 and the second frame 704 are not consecutive and are used for illustrative purposes only. The first frame 702 and the second frame 704 are two frames from the sequence of frames. Multiple frames may be present between the first frame 702 and the second frame 704.

In one configuration, deformation invariant expansion expands possible actor locations to neighboring regions of a number of consecutive frames from the current frame. That is, the deformation invariant expansion may fill in the gaps caused by the actor detector's failure to identify deformed actors. Based on the possible actor locations generated by the actor detector, a similarity-based object tracker expands the possible actor locations over time to improve the actor detection over the sequence of frames.

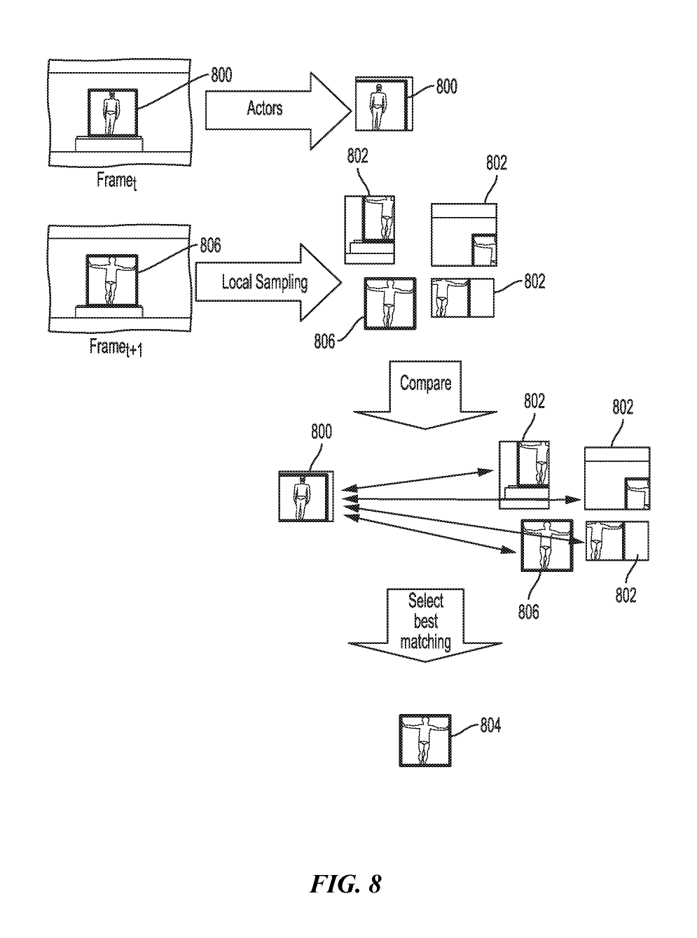

The deformation invariant expansion expands the detections of a current frame to a number of consecutive frames to find a best match region in each frame. FIG. 8 illustrates an example of matching based on to the deformation invariant expansion, according to aspects of the present disclosure. As shown in FIG. 8, a possible action location 800 (e.g., box proposal) is detected at a current frame t. Based on the possible action location 800 of the current frame t, possible action location samples 802 are generated for a number of consecutive frames. For brevity, in the current example, the number of consecutive frames is one (e.g., subsequent frame t+1). Still, the number of consecutive frames is not limited to only a subsequent frame from the current frame. Rather, any number of frames may be used, such that a best match region is determined for each frame from frame t+1 to frame t+n.

The possible action location samples 802 for the subsequent frame t+1 are generated by sampling neighboring areas of the possible action location 800 of the current frame t. The subsequent frame t+1 also includes a possible action location sample 806 generated by an actor detector. The possible action location samples 802, 806 of the subsequent frame t+1 are compared to the possible action location 800 of the current frame t. Based on the comparison, a possible action location sample 802, 806 of the subsequent frame t+1 having a highest similarity to the possible action location 800 of the current frame t is selected as a best possible action location 804 in the subsequent frame t+1. The process continues for each frame of the sequence of frames. One or more possible action locations may be generated for each actor in a frame. The matching of the deformation invariant expansion may be a learned similarity function, such as a Siamese network, or any type of matching function.

According to aspects of the present disclosure, if the actor was misdetected in a frame t+1, such that the action proposal is incorrect, the actor location may be recovered based on the deformation invariant expansion. That is, the deformation invariant expansion may reduce the effects of actor deformation variation. For example, if an actor is performing a backflip. The actor detector may accurately propose an action proposal before and after the backflip. Still, the action proposals during the backflip may be incorrect as the actor detector may not be able to identify the actor's shape during the backflip. The deformation invariant expansion (e.g., deformation and weighted expansion) mitigates the misdetection by connecting the accurate bounding boxes over time, such that the action proposals are accurate over the sequence of frames (e.g., before, during, and after the backflip). Aspects of the present disclosure are not limited to connecting multiple accurate bounding boxes over time. In one configuration, the misdetection may be mitigated by using the deformation invariant expansion with one accurate bounding box.

As previously discussed, one or more bounding boxes may be generated for each actor in a frame. Additionally, a best match region may be generated based on the deformation invariant expansion. In one configuration, a tube is generated by maximizing the affinity between actors in each frame. That is, a most similar region is associated over the sequence of frames to generate the action proposal.

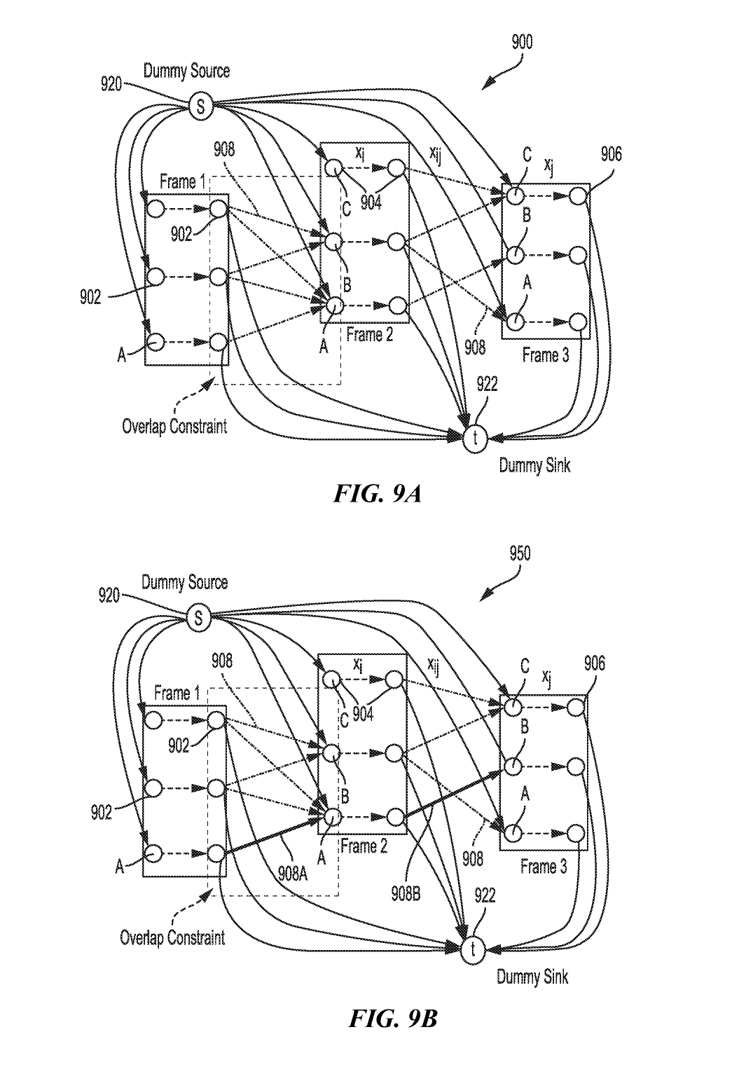

FIGS. 9A and 9B illustrate examples of associating similar action proposals based on an affinity maximization, according to aspects of the present disclosure. The associated action proposals may be used to generate the action proposals for the sequence of frames. As shown in FIG. 9A, each possible action location of a first frame (t) corresponds to a node of first frame nodes 902 in a graph 900. Frame nodes 902, 904, 906 may correspond to a possible action location based on an actor detected by an actor detector or based on a best match region determined from a deformation invariant expansion (e.g., expansion and matching). Each of the first frame nodes 902 is associated with one or more second frame nodes 904 of a second frame (t+1). Likewise, each of the second frame nodes 904 is associated with one or more third frame nodes 906 of a third frame (t+2). For clarity, only a few frame nodes 902, 904, 906 are labeled in FIGS. 9A and 9B.

The frame nodes 902, 904, 906 of one frame are associated with one or more frame nodes 902, 904, 906 of one or more consecutive frames that are in a similar region. For example, a region corresponding to a first frame node A of the first frame nodes 902 may be similar to a region corresponding to a second frame node A of the second frame nodes 904. The region refers to a location in the frame associated with the possible action location of a best match region determined from a deformation invariant expansion.

In this example, the region corresponding to the first frame node A is not similar to a region corresponding to a second frame node B and a second frame node C. As such, as shown in FIG. 9B, the first frame node A is only associated with the second frame node A. The region refers to an area in a frame. For example, if a possible action location in a first frame is in a center region of the first frame, a similar region would be a center region of a second frame. Likewise, a corner region of the second frame would be a different region from the center region of the first frame.

The association is performed between the nodes of consecutive frames (e.g., neighboring frames) in a temporal window of the sequence of frames. In this example, the first frame (t), second frame (t+1), and third frame (t+2) are neighboring frames. In one configuration, an overlap constraint determines the temporal window. The temporal window determines which frame nodes 902, 904, 906 are to be considered for a connection. For example, if the temporal window has a length of one, only second frame nodes 904 are considered for a connection to the first frame nodes 902. As another example, if the temporal window has a length of two, the second frame nodes 904 and the third frame nodes 906 are considered for a connection to the first frame nodes 902. By increasing the overlap constraint, the network increases a detection range for a connection. The overlap constraint may be set to consider actor detectors with low sensitivity. In the example of FIG. 9A, the overlap constraint is one.

Each edge 908 between the frame nodes 902, 904, 906 represents a similarity between connected nodes (e.g., actor boxes). Given the number of frame nodes 902, 904, 906 in each frame, aspects of the present disclosure identify the most similar nodes over time to generate the action proposals. For example, as shown in a graph 950 of FIG. 9B, based on a comparison between the first frame nodes 902 and the second frame nodes 904, an affinity maximization module may determine that the first frame node A of the first frame nodes 902 has a greatest similarity to the second frame node A of the second frame nodes 904. The possible action location corresponding to the first frame node A and the possible action location corresponding to the second frame node A are selected as the action proposals for the respective frames.

Based on the first frame node A having the greatest similarity to the second frame node A, a first edge 908A between the first frame node A and the second frame node B may be set to one. The other edges 908 from the other first frame nodes 902 to the second frame node A and second frame node B may be set to zero. Furthermore, because the second frame node A is most similar to the first frame node A, the second frame node A is compared with each of the third frame nodes 906. The possible action location corresponding to the third frame nodes 906 with the greatest similarity to the second frame node A is selected for the action proposal for the third frame (t+2). For example, third frame node B may have the greatest similarity to second frame node A. Therefore, a second edge 908B between the third frame node B and the second frame node A is set to one. The other edges 908 to third frame node A and third frame node C may be set to zero.

Generating the action proposals may be considered a flow maximization task where the most similar nodes are identified. The similarity may be determined based on a comparison of bounding box locations or a comparison of visual features between two bounding boxes. That is, an affinity between a pair of boxes from consecutive frames may be determined based on an appearance comparison, a location comparison, and/or motion models. The action proposals of the sequence of frames is determined by maximizing a global affinity of the network.

In FIGS. 9A and 9B, a dummy source 920 and a dummy sink 922 are slack nodes that account for variations when action proposals do not start at an initial frame or end at a final frame. For example, a second frame node C may originate at the second frame. Therefore, the second frame node C does not have connections to any of the first frame nodes 902. The affinity maximization may be determined based on equation 1:

$${min}_{x} {\sum }_{i} {c}_{i} {x}_{i} + {\sum }_{ij ∈ E} {c}_{ij} {x}_{ij} \\ \begin{matrix}\begin{matrix}0 \leq {x}_{i} \leq 1 , 0 \leq {x}_{ij} \leq 1 \\ s . t . {\sum }_{i : ij ∈ E} {x}_{ij} = {x}_{j} = {\sum }_{i : ji ∈ E} {x}_{ji}\end{matrix} \\ {\sum }_{i} {x}_{it} = K = {\sum }_{i} {x}_{si}\end{matrix} \} ∈ {FLOW}_{K} \qquad ( 1 )$$

where cᵢ is a confidence (e.g., level of certainty) of a detection i at frame t. The confidence is determined by the object detector or a matching confidence. cᵢⱼ defines the similarity (e.g., affinity) between a node i (e.g., detection i) at frame t and a node j at frame t+1. The similarity may be determined from the similarity of the bounding boxes, the spatial difference between the bounding box locations (e.g., an intersection over union), a cosine similarity between features obtained from the bounding boxes, etc.

The variables xᵢ, xⱼ, xⱼᵢ, and xᵢⱼ are integer variables, between zero and one. The node selections are tracked from xᵢ, xⱼ, xⱼᵢ, and xᵢⱼ. When xᵢ or xⱼ is one, a node has been selected for a path. When xᵢ or xⱼ is zero, a node has not been selected for a path. When xⱼᵢ or xᵢⱼ is one, node i and node j should be connected, when xⱼᵢ or xᵢⱼ is zero, node i and node j should not be connected. Σᵢxᵢₜ=K=Σᵢxₛᵢ is a constraint for limiting the action proposal selection to K action proposals. xₛᵢ and xᵢₜ represent the edge variables connecting the node xᵢ to the dummy source and dummy sink, respectively. xᵢ and xᵢⱼ provide a path (e.g., tube) having the minimum cost and/or a maximum affinity. Determining the path with the minimum cost and/or a maximum affinity may be a linear programming task with a tractable solution. In equation 1, x is a confidence value determining the probability that a node (xᵢ) or an edge (xᵢⱼ) belongs to the proposal. The confidence values may be extracted from the actor detector. Alternatively, the confidence values are based on the similarity between the actor boxes across frames. FLOWₖ is a superset of all possible combinations used to search for an optimal combination.

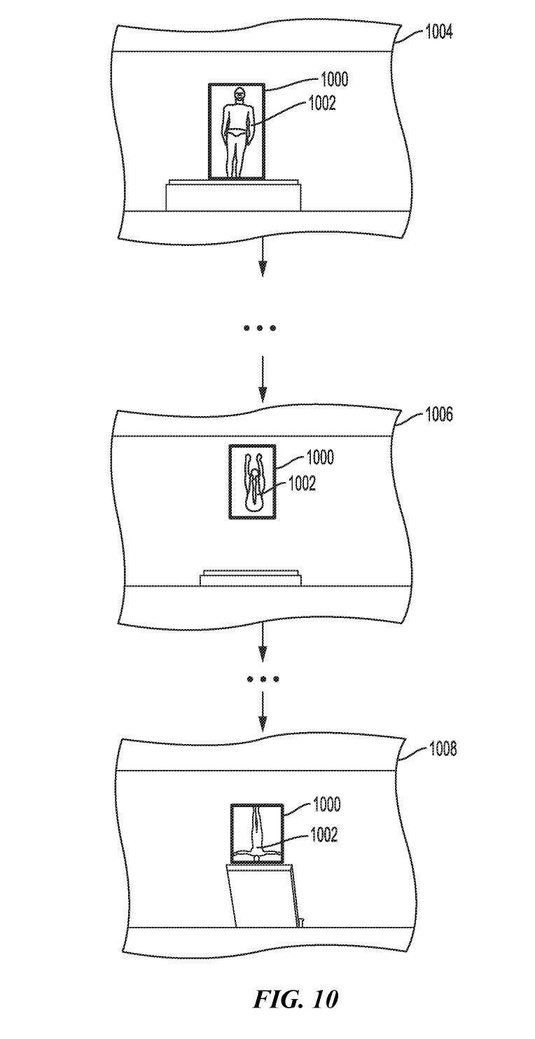

FIG. 10 illustrates an example of generating an action proposal 1000 according to aspects of the present disclosure. As shown in FIG. 10, the action proposal 1000 is provided around an actor 1002 at a first frame 1004. The actor 1002 performs a dive and the action proposal 1000 is consistently around the actor 1002 over the sequence of frames (e.g., second frame 1006 and third frame 1008). In the example of FIG. 10, the first frame 1004, second frame 1006, and third frame 1008 are not consecutive and are used for illustrative purposes only. The first frame 1004, second frame 1006, and third frame 1008 are three frames from the sequence of frames. Multiple frames may be present between the first frame 1004 and second frame 1006, and between the second frame 1006 and the third frame 1008.

In contrast to conventional systems that lose track of an actor during a deformation, aspects of the present disclosure do not lose track of the actor. As discussed above, the action proposals are improved by generating an action proposal having the minimum cost and/or a maximum affinity based on an actor detector and a deformation invariant expansion.

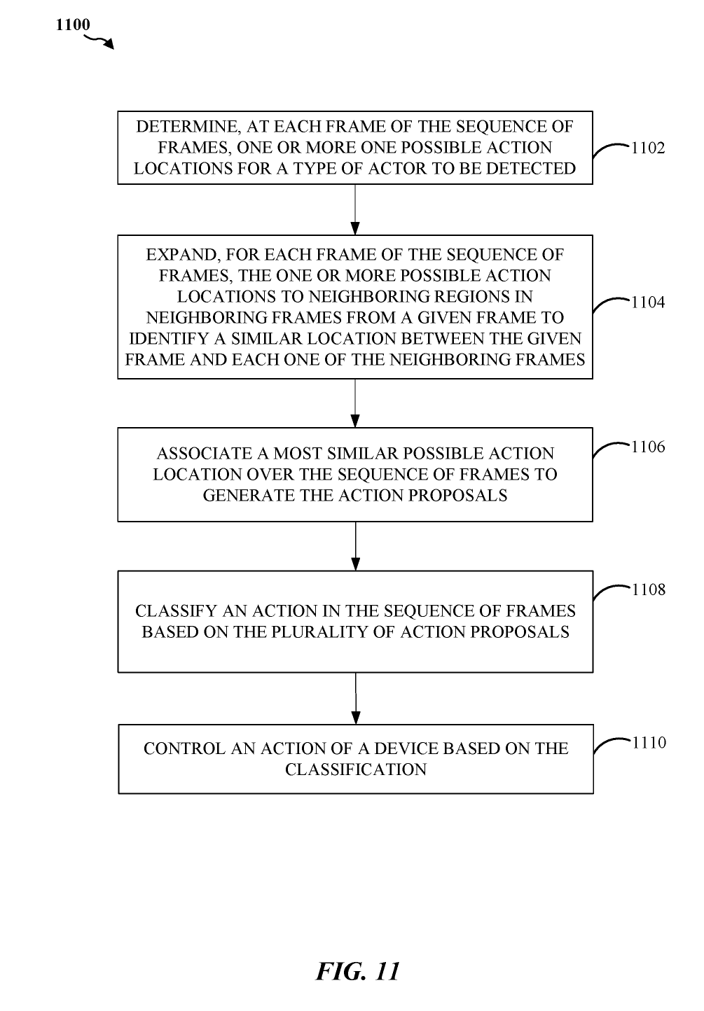

FIG. 11 illustrates a method 1100 for processing a sequence of frames according to an aspect of the present disclosure. As shown in FIG. 11, at block 1102, a machine based vision system determines, at each frame of the sequence of frames, one or more possible action locations for a type of actor to be detected. In an optional configuration, the type of actor to detect is defined based on an application of a machine based vision system. The type of actor to detect is action class agnostic.

At block 1104, the machine based vision system expands, for each frame of the sequence of frames, the one or more possible action locations to neighboring regions in neighboring frames from a given frame to identify a similar location between the given frame and each one of the neighboring frames. To expand the one or more possible action locations, the machine based vision system may compare neighboring regions of frames in the neighboring frames to the one or more possible action locations of the given frame. The machine based vision system may also identify one neighboring region of the neighboring regions as the similar location based on the neighboring region having a greatest similarity to the one or more possible action locations.

At block 1106, the machine based vision system associates a most similar possible action location over the sequence of frames to generate the action proposals. To associate a most similar possible action location, the machine based vision system may compare possible action locations in a first frame to possible action locations in a second subsequent frame. The comparison may compare a learned similarity between possible action locations in the first frame and possible action locations in the second subsequent frame. The learned similarity may be a learned semantic visual feature similarity between possible action locations in the first frame and possible action locations in the second subsequent frame. Additionally, each possible action location corresponds to the one or more possible action locations based on the type of actor or the similar location identified by expanding the one or more possible action locations.

The machine based vision system may further determine a possible action location in the first frame and a possible action location in the second frame with a greatest learned similarity based on the comparison. At block 1108, the machine based vision system classifies an action in the sequence of frames based on the action proposals. Finally, at block 1110, the machine based vision system controls an action of a device based on the classification. For example, the device may be an autonomous vehicle and the classification may classify an action near the autonomous vehicle. As one example, the machine based vision system classifies a walking pedestrian. Based on the classified action, the autonomous vehicle may plan a route that avoids the pedestrian.

As another example, metadata may be added to the sequence of frames to tag (e.g., identify) the classified action. Based on the metadata, a device may be used to find a specific sequence of frames based on a text based search. As one example, various videos may include different actions, such as jumping, diving, shooting a basketball, etc. Metadata may be added to each video to identify the classified action. Each video may be stored in a database and retrieved based on a text-based search. For example, a user may retrieve diving videos by searching for “diving.”

In some aspects, the method 1100 may be performed by the SOC 100 (FIG. 1). That is, each of the elements of the method 1100 may, for example, but without limitation, be performed by the SOC 100 or one or more processors (e.g., CPU 102) and/or other included components.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for processing a sequence of frames, comprising:
determining, at each frame of the sequence of frames, at least one possible action location for a type of actor to be detected;
expanding, for each frame of the sequence of frames, the at least one possible action location to neighboring regions in neighboring frames from a given frame to identify a similar location between the given frame and each one of the neighboring frames;
associating a most similar possible action location over the sequence of frames to generate the plurality of action proposals;
classifying an action in the sequence of frames based on the plurality of action proposals; and
controlling an action of a device based on the classifying.

2. The method of claim 1, further comprising defining the type of actor to detect based on an application of a machine based vision system, in which the type of actor to detect is action class agnostic.

3. The method of claim 1, in which expanding the at least one possible action location comprises:
comparing neighboring regions of frames in the neighboring frames to the at least one possible action location of the given frame; and
identifying one neighboring region of the neighboring regions as the similar location based on the one neighboring region having a greatest similarity to the at least one possible action location.

4. The method of claim 1, in which associating the most similar possible action location comprises:
comparing possible action locations in a first frame to possible action locations in a second subsequent frame; and
determining a possible action location in the first frame and a possible action location in the second frame with a greatest learned similarity based on the comparing.

5. The method of claim 4, in which the comparing comprises comparing a learned similarity between possible action locations in the first frame and possible action locations in the second subsequent frame.

6. The method of claim 5, in which the learned similarity is a learned semantic visual feature similarity between possible action locations in the first frame and possible action locations in the second subsequent frame.

7. The method of claim 4, in which each possible action location corresponds to the at least one possible action location based on the type of actor or the similar location identified by expanding the at least one possible action location.

8. An apparatus for processing a sequence of frames, the apparatus comprising:
a memory; and
at least one processor coupled to the memory, the at least one processor configured:
to determine, at each frame of the sequence of frames, at least one possible action location for a type of actor to be detected;
to expand, for each frame of the sequence of frames, the at least one possible action location to neighboring regions in neighboring frames from a given frame to identify a similar location between the given frame and each one of the neighboring frames;
to associate a most similar possible action location over the sequence of frames to generate the plurality of action proposals;
to classify an action in the sequence of frames based on the plurality of action proposals; and
to control an action of a device based on the classification.

9. The apparatus of claim 8, in which the at least one processor is further configured to define the type of actor to detect based on an application of a machine based vision system, in which the type of actor to detect is action class agnostic.

10. The apparatus of claim 8, in which at least one processor is configured to expand the at least one possible action location by:
comparing neighboring regions of frames in the neighboring frames to the at least one possible action location of the given frame; and
identifying one neighboring region of the neighboring regions as the similar location based on the one neighboring region having a greatest similarity to the at least one possible action location.

11. The apparatus of claim 8, in which at least one processor is configured to associate the most similar possible action location by:
comparing possible action locations in a first frame to possible action locations in a second subsequent frame; and
determining a possible action location in the first frame and a possible action location in the second frame with a greatest learned similarity based on the comparing.

12. The apparatus of claim 11, in which at least one processor is configured to compare the possible action locations by comparing a learned similarity between possible action locations in the first frame and possible action locations in the second subsequent frame.

13. The apparatus of claim 12, in which the learned similarity is a learned semantic visual feature similarity between possible action locations in the first frame and possible action locations in the second subsequent frame.

14. The apparatus of claim 11, in which each possible action location corresponds to the at least one possible action location based on the type of actor or the similar location identified by expanding the at least one possible action location.

15. An apparatus for processing a sequence of frames, the apparatus comprising:
means for determining, at each frame of the sequence of frames, at least one possible action location for a type of actor to be detected;
means for expanding, for each frame of the sequence of frames, the at least one possible action location to neighboring regions in neighboring frames from a given frame to identify a similar location between the given frame and each one of the neighboring frames;
means for associating a most similar possible action location over the sequence of frames to generate the plurality of action proposals;
means for classifying an action in the sequence of frames based on the plurality of action proposals; and
means for controlling an action of a device based on the classifying.

16. The apparatus of claim 15, further comprising means for defining the type of actor to detect based on an application of a machine based vision system, in which the type of actor to detect is action class agnostic.

17. The apparatus of claim 15, in which the means for expanding the at least one possible action location comprises:
means for comparing neighboring regions of frames in the neighboring frames to the at least one possible action location of the given frame; and
means for identifying one neighboring region of the neighboring regions as the similar location based on the one neighboring region having a greatest similarity to the at least one possible action location.

18. The apparatus of claim 15, in which the means for associating the most similar possible action location comprises:
means for comparing possible action locations in a first frame to possible action locations in a second subsequent frame; and
means for determining a possible action location in the first frame and a possible action location in the second frame with a greatest learned similarity based on the comparing.

19. The apparatus of claim 18, in which the means for comparing comprises means for comparing a learned similarity between possible action locations in the first frame and possible action locations in the second subsequent frame.

20. The apparatus of claim 19, in which the learned similarity is a learned semantic visual feature similarity between possible action locations in the first frame and possible action locations in the second subsequent frame.

21. The apparatus of claim 18, in which each possible action location corresponds to the at least one possible action location based on the type of actor or the similar location identified by expanding the at least one possible action location.

22. A non-transitory computer-readable medium having program code recorded thereon for processing a sequence of frames, the program code executed by a processor and comprising:
program code to determine, at each frame of the sequence of frames, at least one possible action location for a type of actor to be detected;
program code to expand, for each frame of the sequence of frames, the at least one possible action location to neighboring regions in neighboring frames from a given frame to identify a similar location between the given frame and each one of the neighboring frames;
program code to associate a most similar possible action location over the sequence of frames to generate the plurality of action proposals;
program code to classify an action in the sequence of frames based on the plurality of action proposals; and
program code to control an action of a device based on the classification.

23. The non-transitory computer-readable medium of claim 22, in which the program code further comprises program code to define the type of actor to detect based on an application of a machine based vision system, in which the type of actor to detect is action class agnostic.

24. The non-transitory computer-readable medium of claim 22, in which the program code to expand the at least one possible action location comprises:
program code to compare neighboring regions of frames in the neighboring frames to the at least one possible action location of the given frame; and
program code to identify one neighboring region of the neighboring regions as the similar location based on the one neighboring region having a greatest similarity to the at least one possible action location.

25. The non-transitory computer-readable medium of claim 22, in which the program code to associate the most similar possible action location comprises:
program code to compare possible action locations in a first frame to possible action locations in a second subsequent frame; and
program code to determine a possible action location in the first frame and a possible action location in the second frame with a greatest learned similarity based on the comparing.

26. The non-transitory computer-readable medium of claim 25, in which program code to compare the possible action locations comprises program code to compare a learned similarity between possible action locations in the first frame and possible action locations in the second subsequent frame.

27. The non-transitory computer-readable medium of claim 26, in which the learned similarity is a learned semantic visual feature similarity between possible action locations in the first frame and possible action locations in the second subsequent frame.

28. The non-transitory computer-readable medium of claim 25, in which each possible action location corresponds to the at least one possible action location based on the type of actor or the similar location identified by expanding the at least one possible action location.
